(19) United States
(12) Patent Application Publication
(10) Pub. No.: US 2019/0212572 A1
(43) Pub. Date: Jul. 11, 2019

(54) OPTICAL SHAPING APPARATUS, MANUFACTURING METHOD, AND STORAGE MEDIUM

(71) Applicant: CANON KABUSHIKI KAISHA, Tokyo (JP)

(72) Inventor: Yuichi Tomioka, Utsunomiya-shi (JP)

(21) Appl. No.: 16/299,324

(22) Filed: Mar. 12, 2019

Related U.S. Application Data
(63) Continuation of application No. PCT/JP2017/034180, filed on Sep. 22, 2017.

(30) Foreign Application Priority Data
Sep. 29, 2016 (JP) 2016-191241

(51) Int. Cl. G02B 27/22; G06F 9/30; H04N 13/167

(52) U.S. Cl. CPC G02B 27/2271; H04N 13/167; G06F 9/3004

(57) ABSTRACT

An optical shaping apparatus includes a light modulation element having a plurality of pixels and configured to modulate light from a light source for each pixel, a convertor configured to convert three-dimensional data into a plurality of two-dimensional modulation control data using conversion information, a controller configured to control the light modulation element based on each of the plurality of two-dimensional modulation control data, and a moving member configured to move a cured portion cured by the modulation light among the photocurable resin in a direction separating from the light-transmissive portion. The convertor sets the conversion information for each data area corresponding to each of a plurality of resin areas in the three-dimensional shape data based on a distribution of a curing shrinkage factor in the plurality of resin areas that receive the modulation light in the photocurable resin.

### CROSS-REFERENCE TO RELATED APPLICATIONS

This application is a Continuation of International Patent Application No. PCT/JP2017/034180, filed on Sep. 22, 2017, which claims the benefit of Japanese Patent Application No. 2016-191241, filed on Sep. 29, 2016, both of which are hereby incorporated by reference herein in their entirety.

### BACKGROUND OF THE INVENTION

### Field of the Invention

The present invention relates to a technology for curing a photocurable resin and for shaping a three-dimensional object.

### Description of the Related Art

The three-dimensional shaping generates two-dimensional shape data (image data) for each position in a height direction from three-dimensional shape data representing a shape of a three-dimensional object, sequentially forms and laminates a shaped layer having a shape corresponding to each of sectional shape data, and obtains a three-dimensional object (a shaped object). As one three-dimensional shaping method of this type, Japanese Patent Laid-Open No. (“JP”) 2015-016610 discloses a method using a photocurable resin.

More specifically, a bottom surface of a container storing a liquid photocurable resin is formed of a light transmitting plate, and the photocurable resin is cured by the light irradiated from a bottom side of the light transmitting plate through the light transmitting plate. At this time, a single shaped layer is wholly and simultaneously cured by collectively projecting (irradiating) light modulated according to the sectional shape data through a light modulation element having a plurality of two-dimensionally arrayed pixels. Then, a three-dimensional object can be shaped by repeating the step of upwardly moving the cured shaped layer to form the next shaped layer.

This method can make the time required for shaping shorter than that of a method for sequentially curing the photocurable resin by scanning each laser beam (spot) for each shaped layer.

However, the three-dimensional shaping method disclosed in JP 2015-016610 causes a temperature distribution and a temperature change in the photocurable resin due to the environmental temperature fluctuations, the heat generated by the photocuring of the photocurable resin, and the like. A curing shrinkage factor in the photocurable resin depends on the temperature, and thus distributes and changes in the photocurable resin during shaping. As a result, the three-dimensionally shaped object distorts and the good shaping accuracy cannot be obtained.

### SUMMARY OF THE INVENTION

The present invention provides an optical shaping apparatus and the like which can provide the good shaping accuracy even when a curing shrinkage factor distributes and changes in a photocurable resin during shaping.

An optical shaping apparatus according to one aspect of the present invention includes a container having a light-transmissive portion and configured to store a liquid photocurable resin, a light modulation element having a plurality of pixels and configured to modulate light from a light source for each pixel, an optical system configured to irradiate modulation light from the light modulation element onto the photocurable resin through the light-transmissive portion, a convertor configured to convert three-dimensional data into a plurality of two-dimensional modulation control data using conversion information, a controller configured to control the light modulation element based on each of the plurality of two-dimensional modulation control data, and a moving member configured to move a cured portion cured by the modulation light among the photocurable resin in a direction separating from the light-transmissive portion. The convertor sets the conversion information for each data area corresponding to each of a plurality of resin areas in the three-dimensional shape data based on a distribution of a curing shrinkage factor in the plurality of resin areas that receive the modulation light in the photocurable resin.

A manufacturing method according to another aspect of the present invention configured to manufacture a three-dimensional object includes the steps of storing a liquid photocurable resin in a container having a light-transmissive portion, irradiating modulation light from a light modulation element through the light-transmissive portion onto the photocurable resin by controlling the light modulation element based on each of a plurality of two-dimensional modulation control data generated by converting three-dimensional shape data using conversion information, the light modulation element having a plurality of pixels and being configured to modulate light from a light source for each pixel, moving a cured portion cured by the modulation light among the photocurable resin in a direction separating from the light-transmissive portion, and setting the conversion information for each data area corresponding to each of a plurality of resin areas in the three-dimensional shape data based on a distribution of a curing shrinkage factor in the plurality of resin areas that receive the modulation light in the photocurable resin.

A non-transitory computer-readable storage medium according to another aspect of the present invention stores an optically shaping program that enables a computer in an optical shaping apparatus to execute an optically shaping process. The optical shaping apparatus includes a container having a light-transmissive portion and configured to store a liquid photocurable resin, a light modulation element having a plurality of pixels and configured to modulate light from a light source for each pixel, and an optical system configured to irradiate modulation light from the light modulation element onto the photocurable resin through the light-transmissive portion. The optically shaping process comprising the steps of converting three-dimensional shape data into a plurality of two-dimensional modulation control data using conversion information, controlling the light modulation element based on each of the plurality of two-dimensional modulation control data, moving a cured portion cured by the modulation light among the photocurable resin in a direction separating from the light-transmissive portion, and setting the conversion information for each data area corresponding to each of a plurality of resin areas in the three-dimensional shape data based on a distribution of a curing shrinkage factor in the plurality of resin areas that receive the modulation light in the photocurable resin.

Further features of the present invention will become apparent from the following description of exemplary embodiments with reference to the attached drawings.

### BRIEF DESCRIPTION OF THE DRAWINGS

FIG. 1 illustrates a configuration of a three-dimensionally shaping apparatus according to a first embodiment of the present invention.

FIGS. 2A and 2B illustrate an image forming element and a shaping unit used for the three-dimensionally shaping apparatus according to the first embodiment.

FIG. 3 is a flowchart of a three-dimensional shaping process according to the first embodiment.

FIGS. 4A to 4D illustrate a temperature distribution, a shrinkage factor distribution, a data conversion ratio, and a width of a shaped object in the X direction according to the first embodiment.

FIGS. 5A to 5D illustrate a temperature change, a shrinkage factor change, a data conversion ratio, and a thickness of a shaped object with time according to the first embodiment.

FIG. 6 illustrates a configuration of a three-dimensional shaping apparatus according to a second embodiment of the present invention.

FIG. 7 illustrates a configuration of a three-dimensional shaping apparatus according to a third embodiment of the present invention.

FIG. 8 is a flowchart of a three-dimensional shaping process according to the third embodiment

FIGS. 9A and 9B illustrate a shaping unit for a three-dimensional shaping apparatus according to a fourth embodiment of the present invention.

FIGS. 10A and 10B illustrate image data and a distortion of a shaped object in a conventional apparatus.

FIGS. 11A to 11D illustrate a temperature distribution, a shrinkage factor distribution, a data conversion ratio, and a width of a shaped object in the X direction in the conventional apparatus.

FIGS. 12A to 12D illustrate a temperature change, a shrinkage factor change, a data conversion ratio, and a thickness of a shaped object with time in the conventional apparatus.

### DESCRIPTION OF THE EMBODIMENTS

Referring now to the accompanying drawings, a description will be given of embodiments according to the present invention.

### First Embodiment

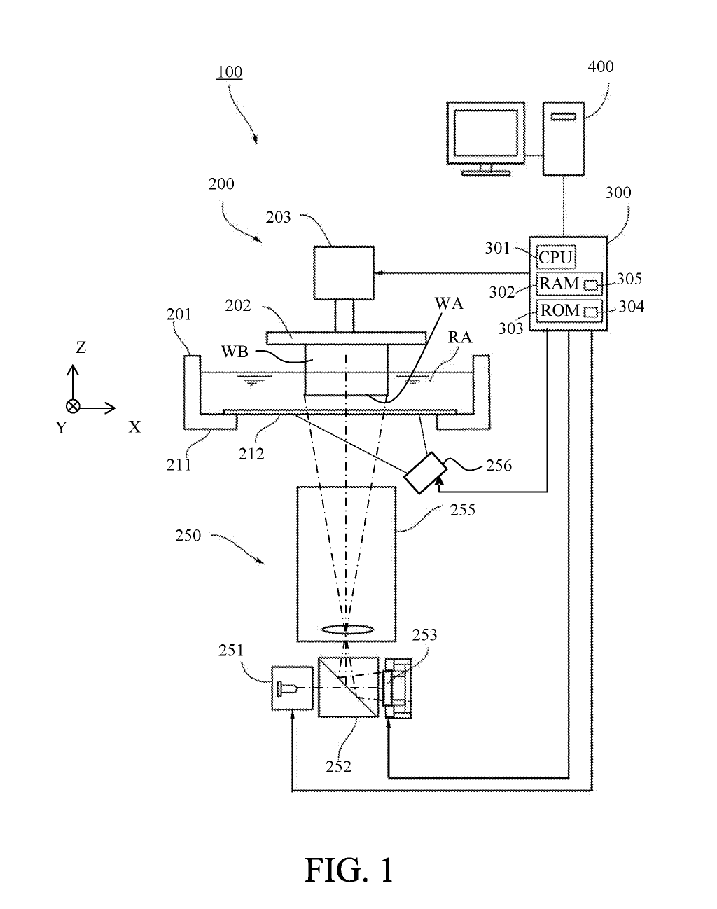

FIG. 1 illustrates a configuration of a three-dimensionally shaping apparatus (optical shaping apparatus) according to a first embodiment of the present invention. A three-dimensionally shaping apparatus 100 forms a three-dimensionally shaped object by sequentially laminating shaped layers formed through irradiating and curing of a liquid photocurable resin with image light described later. This embodiment will illustratively describe image light as ultraviolet light (referred to as UV light hereinafter) and the ultraviolet curable resin (referred to as UV curable resin hereinafter) used as the photocurable resin. However, the image light other than the UV light and the photocurable resin other than the UV curable resin may be used.

The three-dimensionally shaping apparatus 100 includes a shaping unit 200 and a controller 300 for controlling the shaping unit 200. An image processing apparatus 400 as an external computer is connected to the controller 300.

The shaping unit 200 includes a container 201, a holding plate 202 as a moving member, a moving mechanism 203, and a projection unit 250. The container 201 includes a tank for storing a liquid UV curable resin RA, and has an opening in an upper portion. The container 201 includes a container body 211 and a light transmitting plate (light-transmissive portion or light transmitter) 212 having a light transmission property so as to close the opening formed on the bottom surface of the container body 211. The UV curable resin RA has a curing characteristic when receiving the UV light of a predetermined light amount or more. Hence, irradiating the UV light having a predetermined light amount or more only to a region to be cured can form the shaped object WB having an intended shape.

The light transmitting plate 212 has the UV/oxygen transmitting characteristic that transmits the UV light and oxygen. A thin fluoro-resin plate such as Teflon (registered trademark) AF2400 can be used for this light transmitting plate 212. The light transmitting plate 212 transmits oxygen in air and forms an oxygen-rich atmosphere at the interface with the UV-curable resin RA, thereby preventing the UV curable resin RA from being cured by the UV light (radical polymerization reaction). In other words, the UV curable resin RA is characterized in being curable by the UV light, and prevented from being cured in the oxygen-rich environment.

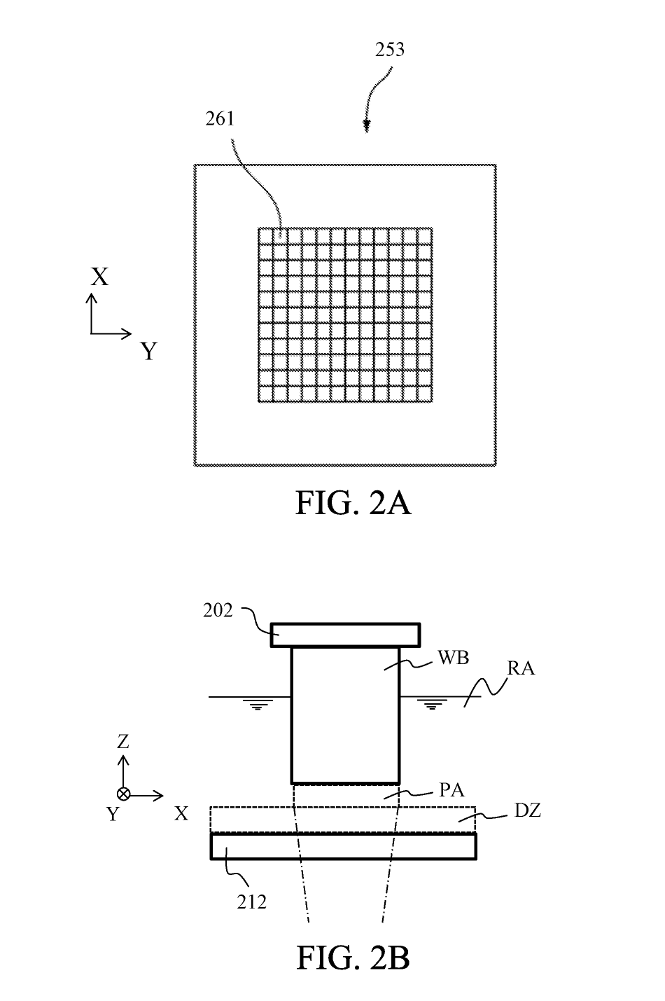

Therefore, as illustrated in FIG. 2B, a dead zone (dead band) DZ in which the UV curable resin RA is not cured even under the UV light is formed in a layer shape near the light transmitting plate 212. Then, a layered portion (referred to as a shaped resin liquid layer hereinafter) located just above the dead zone DZ of the UV curable resin RA is cured by the UV light (image light), thereby forming a shaped layer (intermediate in course of shaping) WA. Thereby, the shaped layer WA never adheres to the light transmitting plate 212.

Oxygen that permeates the light transmitting plate 212 may use oxygen in air as described above, or an unillustrated oxygen supply unit (nozzle) may be disposed near the light transmitting plate 212 to supply oxygen to the light transmitting plate 212. The shaping unit 200 or the entire three-dimensionally shaping apparatus 100 may be placed in a high-pressure oxygen atmosphere.

The moving mechanism 203 moves the holding plate 202 in the vertical direction through the upper opening in the container 201. The moving mechanism 203 includes a pulse motor, a ball screw, and the like, and moves the holding plate 202 at an arbitrary speed or an arbitrary pitch under control of the controller 300. The following description sets the moving direction (vertical direction in the drawing) of the holding plate 202 by the moving mechanism 203 in FIG. 1 to a Z direction (thickness direction) and the direction orthogonal to the Z direction (lateral direction in the drawing) to an X direction. The direction orthogonal to the Z direction and the X direction (the depth direction in the drawing) is set to a Y direction. The moving mechanism 203 moves the holding plate 202 in an (upward) direction separating from the light transmitting plate 212 and in a (downward) direction for making the holding plate 202 closer to the light transmitting plate 212 in the Z direction. During shaping, the holding plate 202 is upwardly moved from the lower end position facing the dead zone DZ. When the image forming light is irradiated onto the UV curable resin RA through the light transmitting plate 212 while the holding plate 202 is located at the lower end position, a first shaped layer is formed and adhered to the holding plate 202. The next shaped layer is laminated and formed on the first shaped layer between the first shaped layer and the dead zone DZ by irradiating the image light onto the UV curable resin RA through the light transmitting plate 212 while the first shaped layer is lifted by a predetermined amount from the lower end position. This procedure can form a shaped object WB in which a plurality of shaped layers WA sequentially formed are laminated.

The projection unit 250 is disposed on the lower side of the container 201. The projection unit 250 includes a UV light source 251, a beam splitter 252, an image forming element 253 as a light modulation element, a driving mechanism 254, and a projection optical system 255. If necessary, another optical element for changing the projection optical path may be added to the projection unit 250.

The UV light source 251, the beam splitter 252, and the light modulation element 253 are arranged in series in the X direction as the horizontal direction. A projection optical system 255 is disposed above (in the Z direction) the beam splitter 252. The projection optical system 255 is disposed so that its light emitting surface faces the light transmitting plate 212.

The UV light source 251 emits the UV light and includes an LED, a high-pressure mercury lamp, or the like. The UV light emitted from the UV light source 251 passes through the beam splitter 252 and irradiates the image forming element 253 with the UV light.

The image forming element 253 has a plurality of pixels, and modulates the irradiated UV light for each pixel to generate image light as modulation light. This embodiment uses a DMD (Digital Micro mirror Device) as the image forming element 253. As illustrated in FIG. 2, the image forming element 253 as the DMD includes a micro mirror in which each of the plurality of two-dimensionally arranged pixels 261 moves (rotates) between two angular positions (ON position and OFF position). Each pixel 261 can provide a binary control in which light and dark are expressed by the ON state where the mirror is located at the ON position and the OFF state where the mirror is located at the OFF position.

The image processing apparatus 400 generates a plurality of original image data as two-dimensional shape data on a plurality of sections in the Z direction from previously prepared three-dimensional shape data as shape data of a three-dimensional object. Each original image data is binary data including 1 indicating that it is a shaping pixel position or 0 indicating that it is a non-shaping pixel position for a plurality of two-dimensional pixel positions. The image processing apparatus 400 outputs to the controller 300 motion image data in which a plurality of original image data are arranged in chronological order.

The controller 300 converts a plurality of original image data (or three-dimensional shape data) in the motion image data into a plurality of corrected image data as a plurality of two-dimensional modulation control data using the following data conversion ratio as conversion information. Through a binary control over each pixel 261 in the image forming element 253 sequentially based on each of the plurality of corrected image data (two-dimensional shape data), as described above, the UV light is modulated for each pixel 261 to generate the image light. The controller 300 can perform a halftone control through a duty control that switches the ON state and OFF state of each pixel 261 at a high speed. The controller 300 also functions as a conversion unit.

This embodiment describes the DMD used as the image forming element 253, but may use a reflection type liquid crystal panel or a transmission type liquid crystal panel as the image forming element 253. That illustration can also provide a halftone representation by high-speed switching of the reflectance or transmittance as well as the light and dark representation by the binary control over the reflectance or transmittance of a pixel. In addition, any element capable of forming the image light having light and dark or halftone can be used as the image forming element 253.

As described above, the beam splitter 252 transmits the UV light from the UV light source 251, and reflects the image light from the image forming element 253 toward the projection optical system 255. The projection optical system 255 includes one or a plurality of lenses, and projects (irradiates) the image light so that the image light from the image forming element 253 (the beam splitter 252) is imaged at a position optically conjugate with the image forming element 253 in the container 201. This embodiment sets the imaging position of the image light to the shaping position. The shaping position is a position just above the dead zone DZ in the container 201, and the shaped layer WA is formed when the shaped resin liquid layer PA located at the shaping position in the UV curable resins RA receives the image light. The shaped layer WA can be formed with a good resolution by imaging or making narrowest the image light from each pixel in the image forming element 253 at the shaping position.

The controller 300 controls the UV light source 251, the moving mechanism 203, the image forming element 253, and the driving mechanism 254 to instruct moving mechanism 203 to continuously or intermittently lift the holding plate 202 at a speed in synchronization with the formation (curing) of the shaped layer WA according to the above motion image. This configuration performs three-dimensional shaping so that the shaped object WB grows while its upper end is held by the holding plate 202.

Hence, the three-dimensionally shaping apparatus 100 according to this embodiment collectively projects the image light from the projection unit 250 to the shaping position in forming each of the plurality of sequentially laminated shaped layers WA and cures the shaped resin liquid layer PA at once. Therefore, the time required for shaping the shaped object WB becomes shorter than another apparatus that forms each shaped layer by scanning a laser beam or by applying the UV curable resin and by then irradiating light onto it.

The controller 300 is configured as a computer that includes a CPU 301, a RAM 302 having a work area used for a calculation in the CPU 301, and a ROM 303. The ROM 303 is a recording medium that records a program 304, and is a rewritable nonvolatile memory, such as an EEPROM. The CPU 301 executes a three-dimensional shaping process (three-dimensional object manufacturing method) described later for controlling the shaping unit 200 by reading the three-dimensional shaping program 304 as a computer program recorded in the ROM 303.

The three-dimensional shaping program 304 may be recorded in a non-transitory computer-readable storage medium, such as a nonvolatile memory (semiconductor memory or the like), a recording disk (optical disk or magnetic disk), and an external storage unit (hard disk drive).

In shaping with the conventional three-dimensional shaping apparatus, the temperature distributes or changes in the UV curable resin due to the environmental fluctuations, the heat generated by photocuring of the UV curable resin, and the like. A curing shrinkage factor in the UV curable resin fluctuates depending on the temperature. Thus, the curing shrinkage factor in the photocurable resin distributes or changes due to the temperature distribution and temperature change generated during shaping. As a result, the shaped object distorts.

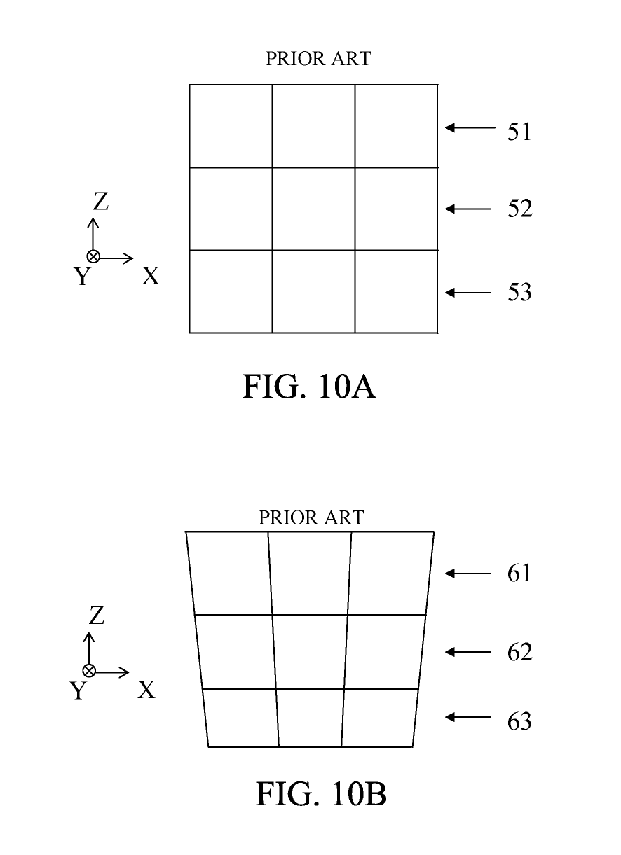

FIG. 10A illustrates an illustrative three-dimensional shape data given to form a cube shaped object. Three original image data 51, 52, and 53 indicating shapes on three sections parallel to the XY plane are obtained from this three-dimensional shape data. Each original image data has a data area divided into three in the X direction (and the Y direction). Also, each original image data is used to shape the unit thickness in three-dimensional shape data.

FIG. 10B illustrates that the conventional three-dimensional shaping apparatus (referred to as a conventional apparatus hereinafter) irradiates image light to the UV curable resin based on the original image data 51, 52, and 53 in FIG. 10A and forms the shaped object. The shaped object is formed by laminating shaped layers 61, 62, and 63 corresponding to the original image data 51, 52, and 53. However, each shaped layer is thinner than a thickness corresponding to the unit thickness in the three-dimensional shape data.

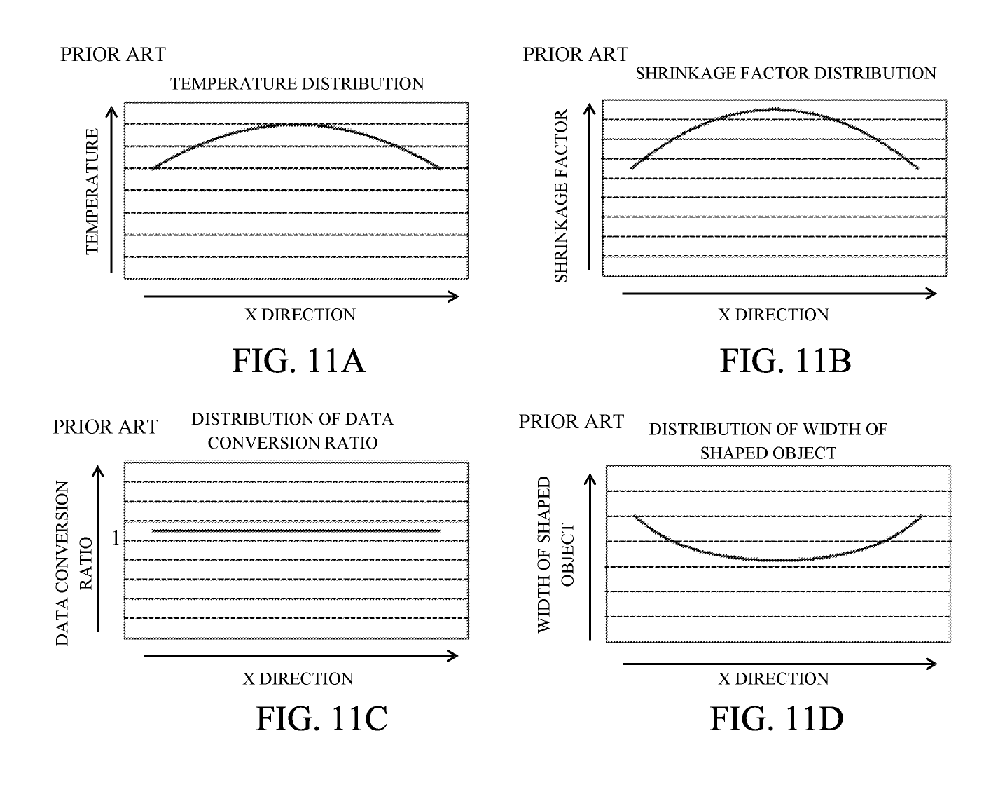

FIG. 11A illustrates an illustrative temperature distribution in the shaped resin liquid layer in the X direction when the conventional apparatus shapes the shaped object illustrated in FIG. 10B. In general shaping of the shaped object, the temperature at the center portion is higher than that at the peripheral portion. FIG. 11B illustrates an illustrative distribution of the curing shrinkage factor in the X direction in the shaped resin liquid layer having the temperature distribution illustrated in FIG. 11A.

The curing shrinkage factor is a ratio obtained by dividing the size (sectional area, volume, width, and thickness) of the pre-cure UV curable resin by the size of the post-cure UV curable resin. When the curing shrinkage factor is 1, the size of the UV curable resin (referred to as a resin size hereinafter) does not change before and after curing, and the resin size that has received the image light is the size of the shaped layer. In addition, when the curing shrinkage factor is larger than 1, the post-cure resin size is smaller than the pre-cure resin size, and the larger the curing shrinkage factor is, the larger a shrinkage amount is. On the contrary, when the curing shrinkage factor is smaller than 1, the post-cure resin size is larger than the pre-cure resin size, and the smaller the curing shrinkage factor is, the larger an expansion amount is. In FIG. 11B, the higher the temperature is, the higher the curing shrinkage factor is.

FIG. 11C illustrates an illustrative data conversion ratio set for a plurality of data areas corresponding to a plurality of resin areas in the X direction of the shaped resin liquid layer in the conventional apparatus. A description will now be given of the data conversion ratios in this embodiment and the conventional apparatus.

The data conversion ratio is, for example, a ratio of the number of pixels on the image forming element 253 to the unit area in the original image data on a single section in the three-dimensional shape data (or the unit area in the three-dimensional shape data), in other words, a ratio of an irradiation area of the modulation light on the UV curable resin (shaped resin liquid layer). When it is assumed that the number of pixels on the image forming element 253 is 1 when the data conversion ratio is 1, the number of pixels on the image forming element 253 becomes larger than 1 when the data conversion ratio is larger than 1. The data conversion ratio is calculated, for example, a ratio of the irradiation time (irradiation light amount) of the image light onto the UV curable resin to the thickness of the shaped layer to be formed based on the original image data on a single section in the three-dimensional shape data (or the unit thickness of the three-dimensional shape data). When it is assumed that the irradiation time to the unit thickness is 1 when the data conversion ratio is 1, the irradiation time becomes larger than 1 when the data conversion ratio is larger than 1.

As illustrated in FIG. 11C, the same data conversion ratio (such as 1) is set for all data areas in the conventional apparatus. In this case, as illustrated in FIGS. 11D and 10B, the shaped object distorts so that the size (width) is smaller at the center portion in the X direction (and the Y direction). This is because the temperature and the curing shrinkage factor at the center portion are higher than those at the peripheral portion.

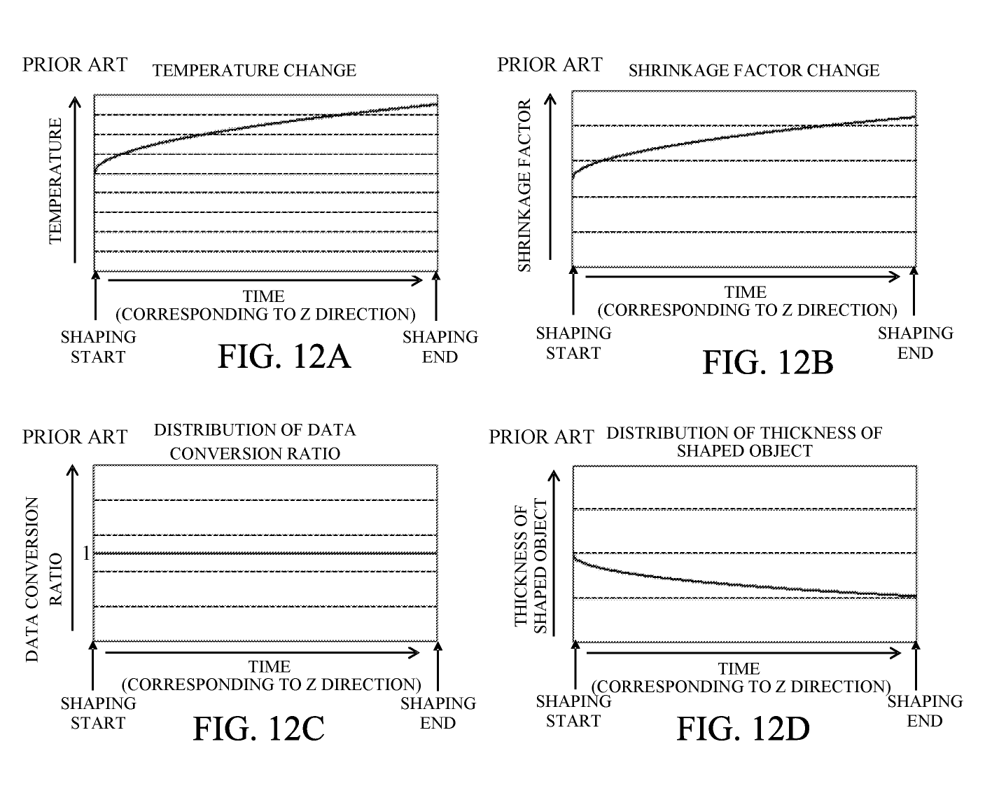

FIG. 12A illustrates an illustrative temperature change in a certain resin area (such as the center portion) in the shaped resin liquid layer with time from the start to the end of the shaping of the shaped object. The heat accumulates in the shaped resin liquid layer and its temperature rises with time from the shaping start. FIG. 12B illustrates an illustrative change in the curing shrinkage factor in the resin area to the temperature change illustrated in FIG. 12A. FIG. 12C illustrates an illustrative data conversion ratio set for a data area to be shaped with time from the shaping start in the conventional apparatus. The same data conversion ratio (such as 1) is always set in the conventional apparatus over time from the shaping start. As a result, as illustrated in FIGS. 12D and 10B, a distortion occurs in the shaped object such that the longer the elapsed time from the start to the end of the shaping is or the higher the temperature of the resin area is, the smaller the size in the Z direction (thickness) becomes. In FIG. 10B, the shaped layer 63 shrunk most in the Z axis direction.

Thus, when the same data conversion ratio is always used during shaping, the shaped object distorts due to the difference (distribution) of the curing shrinkage factor caused by the temperature distribution and temperature change in the shaped resin liquid layer, and the shaped object with a good shaping accuracy cannot be obtained.

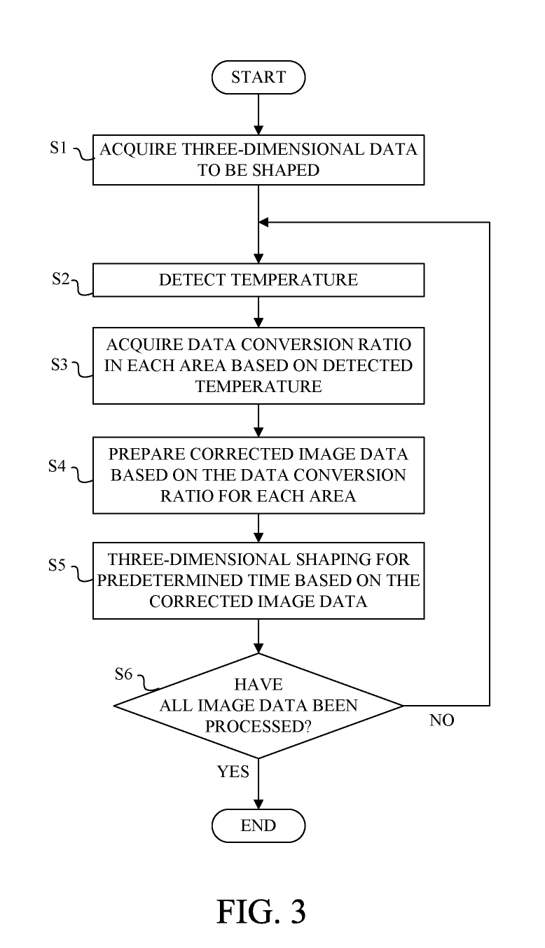

This embodiment executes the three-dimensional shaping processing described below. The flowchart in FIG. 3 illustrates a flow of a three-dimensional shaping process executed by the CPU 301 in the controller 300 in accordance with the above three-dimensional shaping program according to this embodiment.

In the step S1, the CPU 301 acquires from the image processing apparatus 400 motion image data in which a plurality of original image data are chronologically arranged or three-dimensional shape data of a three-dimensional object to be shaped.

Next, in the step S2, the CPU 301 detects (measures) the temperature distribution of the light transmitting plate 212 on the real time basis by using a thermographic sensor (infrared camera) 256 as a temperature detector illustrated in FIG. 1. The light transmitting plate 212 is located near the above shaping position via the dead zone DZ. Thus, detecting the temperature distribution in the light transmitting plate 212 is equivalent with acquiring the temperature distribution of the shaped resin liquid layer PA located at the shaping position. If there is a difference between the temperature distribution in the light transmitting plate 212 and the actual temperature distribution in the shaped resin liquid layer PA, the detected temperature distribution of the light transmitting plate 212 may be corrected and used as the temperature distribution of the shaped resin liquid layer PA.

This embodiment provides a plurality of resin area by dividing the shaped resin liquid layer PA into a plurality of portions in the X direction and the Y direction, respectively, and acquires the temperature for each resin area from the detected temperature distribution. One resin area is an area that receives image light from one or more pixels in the image forming element 253. Detecting the temperature distribution at predetermined time intervals by the thermographic sensor 256 can also detect a temperature change for each resin area. A method of directly detecting the temperature distribution of the shaped resin liquid layer PA may be adopted.

Next, in the step S3, the CPU 301 acquires the above data conversion ratio in the data area corresponding to each of the plurality of resin area for each of the plurality of original image data based on the temperature distribution and the temperature change detected in the step S2. In other words, the CPU 301 acquires the data conversion ratio for each corrected image data generated in the next step S4. Herein, the storage unit 305 in the RAM 302 previously stores a data table including the data conversion ratio for each data area corresponding to a variety of temperature distributions and temperatures, and the CPU 301 reads out of the data table the data conversion ratio corresponding to the detected temperature distribution and temperature. The CPU 301 may calculate the data conversion ratio for each resin area using an arithmetic expression.

In the next step S4, the CPU 301 generates corrected image data by multiplying each original image data acquired in the step S1 by the data conversion ratio for each corresponding data area. Generating the corrected image data corresponds to converting the three-dimensional shape data into the corrected image data using the data conversion ratio.

Next, in the step S5, the CPU 301 sequentially irradiates onto the shaped resin liquid layer PA the image light corresponding to the plurality of corrected image data. The CPU 301 controls the moving mechanism 203 so that the holding plate 202 upwardly moves in synchronization with the irradiation of the image light corresponding to the corrected image data. Thus, the shaped object WB including the plurality of shaped layers WA is thus shaped during the predetermined time period.

Next, in the step S6, the CPU 301 determines whether the irradiation of the image light has been completed for all of the corrected image data. If there is remaining image data, the flow returns to the step S2 and repeats the processing from the step S2 to the step S5 until the irradiation of image light for all image data is completed.

Herein, the temperature in the shaped resin liquid layer PA may change due to the heat generated by photocuring over time from the shaping start of the shaped object and/or the temperature change of the space where the three-dimensional shaping apparatus 100 is installed. Accordingly, this embodiment repeats the processing from the step S2 to the step S4 at the above predetermined time intervals, and then provides shaping in the step S5. In other words, the CPU 301 detects the temperature distribution in the light transmitting plate 212 (the shaped resin liquid layer PA) at predetermined time intervals during shaping, reads a new data conversion ratio from the data table according to the temperature change, and updates the corrected image data. This configuration can suppress the distortion of the shaped layer WA from the start to the end of shaping.

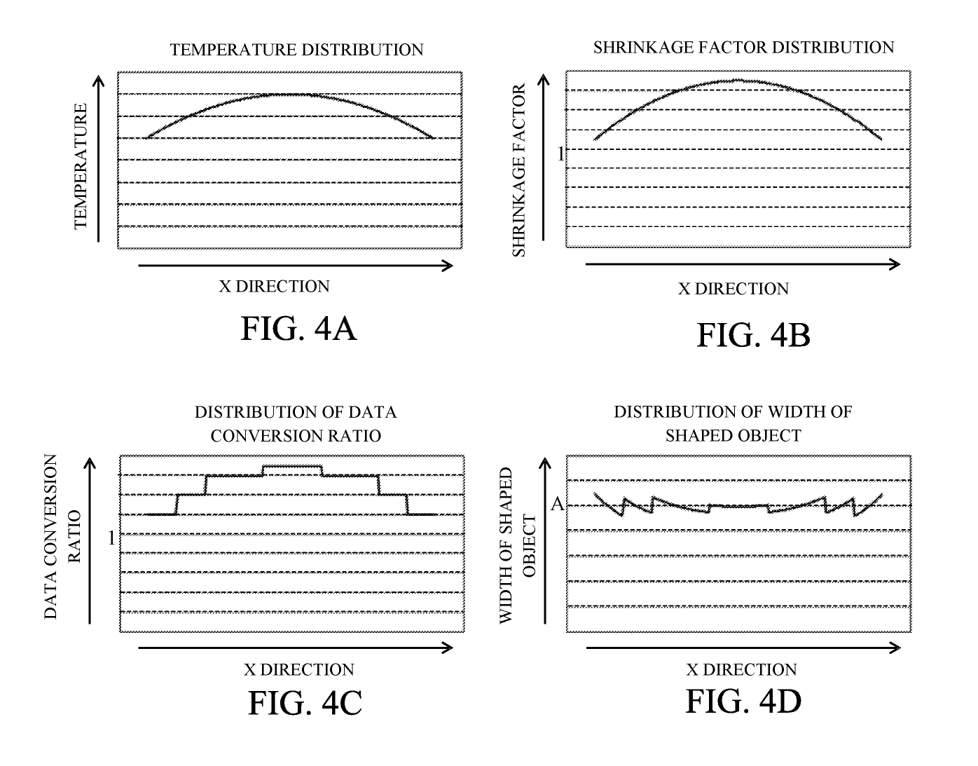

FIG. 4A illustrates an illustrative temperature distribution in the X direction of the shaped resin liquid layer PA in the three-dimensional shaping apparatus 100 according to this embodiment. FIG. 4B illustrates an illustrative distribution of the curing shrinkage factor in the X direction in the shaped resin liquid layer PA when there is the temperature distribution illustrated in FIG. 4A. FIGS. 4A and 4B illustrate the same temperature distribution and cure shrinkage factor distribution as those in FIGS. 11A and 11B, respectively.

FIG. 4C illustrates an illustrative data conversion ratio set for a plurality of data areas corresponding to a plurality of resin areas in the X direction in the shaped resin liquid layer PA, where a temperature distribution illustrated in FIG. 4A is detected in the shaped resin liquid layer PA. Different data conversion ratios are set for different resin areas with different temperatures. More specifically, it is set such that the higher the temperature in the resin area is, the higher the data conversion ratio of the data area corresponding to the resin area becomes or so as to increase the irradiation area of the image light to the unit area in the original image data.

The temperature at the center portion in the X direction is high and the temperature at the peripheral portion is low in FIG. 4A, and accordingly the data conversion ratio for the data area corresponding to the center portion is high and the data conversion ratio for the data area corresponding to the peripheral portion is low in FIG. 4C. In general, the accumulated heat and the temperature at the center portion are higher than those at the peripheral portion in the shaped object, so that the data conversion ratio at the center portion is made higher. Thereby, the image light of a larger irradiation area is irradiated onto the resin area having a higher temperature. As a result, as illustrated in FIG. 4D, the resin size (width) after the resin area having a high temperature and a large curing shrinkage amount is cured can be made equal or close to the resin size (width) A indicated by the original image data.

On the other hand, the lower the temperature in the resin area is, the smaller the data conversion ratio of the data area corresponding to the resin area is set. Thereby, the resin size (width) after the resin area having a low temperature and a small shrinkage amount is cured can be equal or close to the resin size (width) A indicated by the original image data. In other words, irradiating the image light onto the shaped resin liquid layer PA based on the corrected image data obtained by converting the original image data using the data conversion ratio can suppress the distortion (shaping distortion) of the shaped object WB caused by the curing shrinkage factor difference (distribution) due to the temperature distribution of the shaped resin liquid layer PA. Therefore, the shaped object WB can be formed with a good shaping accuracy corresponding to the original image data.

Only the X direction has been described in FIGS. 4A to 4D, but this is similarly applied to the Y direction.

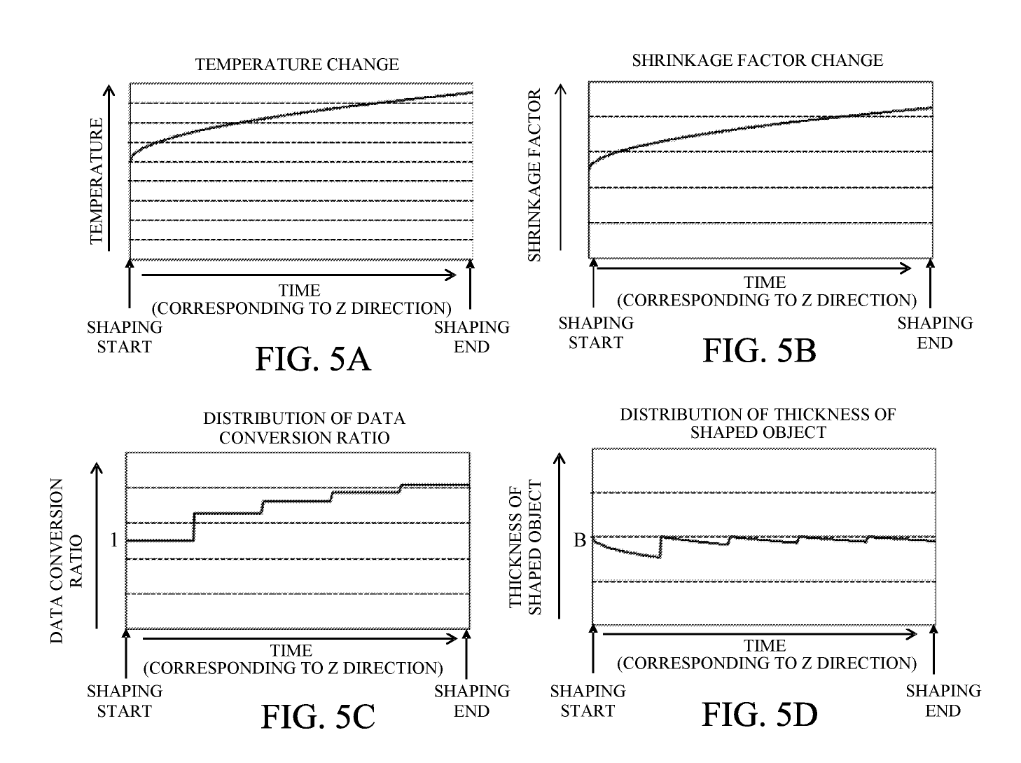

FIG. 5A illustrates an illustrative temperature change in the shaped resin liquid layer PA (such as the resin area at the center portion) over time from the start to the end of shaping. FIG. 5B illustrates an illustrative change in the curing shrinkage factor in the resin area relative to the temperature change illustrated in FIG. 5A. FIGS. 5A and 5B illustrate the same temperature distribution and curing shrinkage factor distribution as those in FIGS. 12A and 12B, respectively.

FIG. 5C illustrates an illustrative change in the data conversion ratio set for the data area (such as the data area at the center of the original image data) when the temperature change illustrated in FIG. 5A is detected. Herein, the temperature is detected at predetermined time intervals, and the data conversion ratio is changed in accordance with the temperature. Since the temperature becomes higher with time from the shaping start, the curing shrinkage factor also increases as illustrated in FIG. 5B. Thus, as illustrated in FIG. 5C, as time elapses or as the temperature in the resin area rises, the data conversion ratio of the data area corresponding to the resin area is made larger. In other words, the data conversion ratio is set such that the higher the temperature in the resin area is, the longer the irradiation time to the unit thickness becomes. A longer irradiation time increases the thickness of the shaped layer WA in the Z direction. Since different shaped layers WA are sequentially formed in the Z direction with time, a different data conversion ratio is set for each data area in the direction corresponding to the Z direction. This is similarly applied to each resin area in the X and Y directions.

Thereby, as illustrated in FIG. 5D, even when a temperature changes, the resin size (thickness) of the cured resin area after the resin area is cured is equal or close to the resin size (thickness) B indicated by the original image data. In other words, irradiating the image light onto the shaped resin liquid layer PA based on the corrected image data obtained by converting each of the plurality of original image data using the data conversion ratio can restrain the shaping distortion caused by the curing shrinkage factor difference caused by the temperature change during shaping. Hence, the shaped object WB can be formed with a good shaping accuracy for the three-dimensional shape data.

Nevertheless, in making the data conversion ratios different for each data area in the X and Y directions, the data conversion ratio made different at the exact data area position may cause overlapping and spacing at the boundary between the adjacent resin areas (the post-cure areas) in the shaped object. Accordingly, this embodiment sets the origin of the data conversion to the center of the shaped object (or three-dimensional shape data) or the center of the temperature distribution, and performs the data conversion in accordance with the data conversion ratio in order from the data area near the origin, suppressing the overlapping and spacing. The center of the shaped object can be set to the origin because it is generally likely to be the center of the temperature distribution and then the center of the shaped object becomes the center of the curing shrinkage factor distribution and the data conversion ratio has an extreme value. Hence, the center of the modeled object set to the origin can suppress the above overlapping and spacing in many cases.

The data area and temporal division numbers that make the data conversion ratios different in FIGS. 4A to 4D and 5A to 5D are merely illustrative for description purposes, and the division number set as large as possible can satisfactorily suppress the undulation of the shaped object.

### Second Embodiment

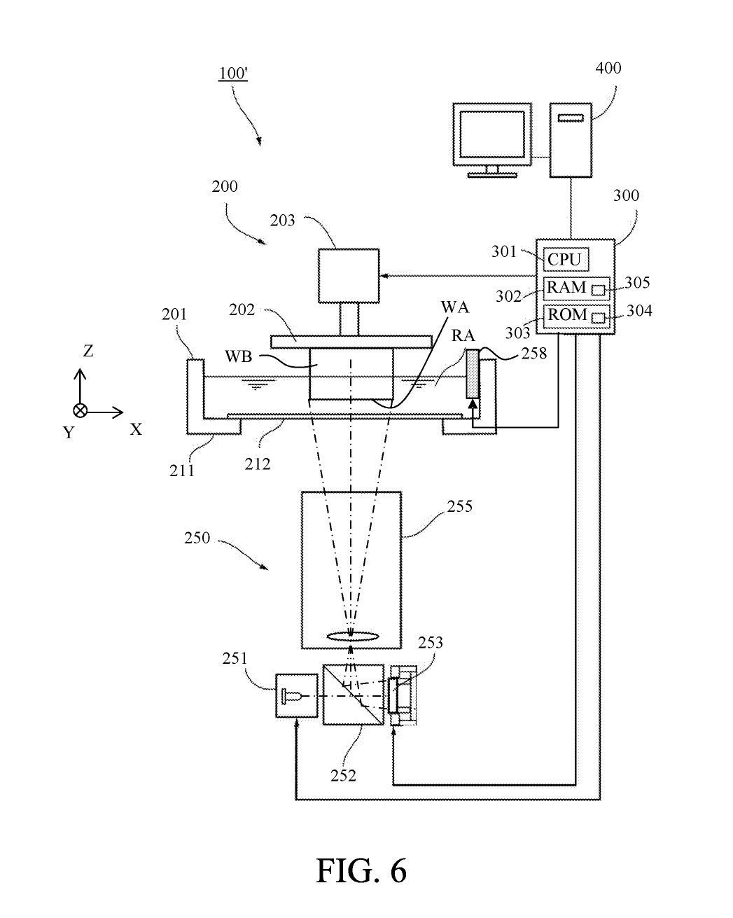

Referring now to FIG. 6, a description will be given of a three-dimensional processing apparatus 100′ according to a second embodiment of the present invention. The basic configuration of the three-dimensional processing apparatus 100′ according to this embodiment is the same as that of the first embodiment, and common elements will be designated by the same reference numerals as those in the first embodiment and a description thereof will be omitted.

This embodiment provides a temperature sensor 258 configured to detect the temperature in the UV curable resin RA in the container 201. Thereby, the temperature (change) in the UV curable resin RA is detected directly on the real time basis.

Even this embodiment sets the data conversion ratio, as described with reference to FIGS. 5A to 5D in the first embodiment, over time from the shaping start (data area in a direction corresponding to the Z direction in the three-dimensional data) based on the temperature change in the UV curable resin RA. This configuration can suppress the shaping distortion caused by the change in the curing shrinkage factor caused by the temperature change during shaping.

### Third Embodiment

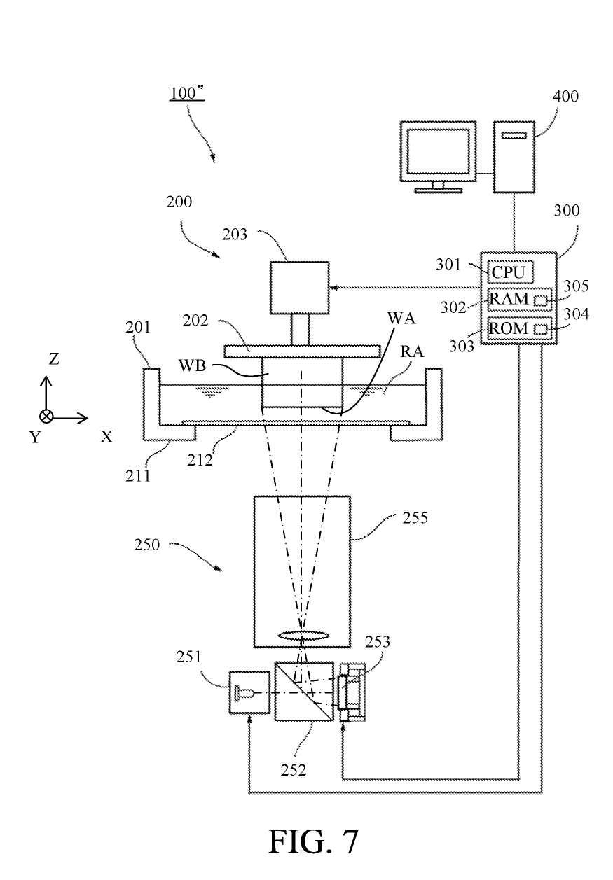

Referring now to FIG. 7, a description will be given of a three-dimensional processing apparatus 100″ according to a third embodiment of the present invention. The basic configuration of the three-dimensional processing apparatus 100″ according to this embodiment is the same as that of the first embodiment, and common elements will be designated by the same reference numerals as those in the first embodiment and a description thereof will be omitted.

The first and second embodiments detect the temperature distribution and the temperature change in the UV curable resin RA using the thermographic sensor 256 and the temperature sensor 258. On the other hand, this embodiment provides no sensor for detecting the temperature, predicts a temperature distribution and a temperature change during shaping based on three-dimensional shape data, and sets the data conversion ratio for each data area in the direction(s) corresponding to the X direction (and the Y direction) and the Z direction based on the prediction result. Thereby, a simpler apparatus configuration that has no thermographic sensor 256 or no temperature sensor 258 can suppress the shaping distortion.

Analyzing the three-dimensional shape data used to shape the shaped object can previously provide irradiation schedule information as information such as the irradiation timing and the number of irradiations of the image light for each resin area in the UV curable resin RA during shaping. The temperature distribution and temperature change in the UV curable resin RA during shaping can be predicted based on the irradiation schedule information for each resin area. In other words, the irradiation schedule information of the image light predicted from the three-dimensional shape data can be used as the information on the temperature distribution and the temperature change.

More specifically, the temperature distribution and the temperature change are predicted from the result of moving average of the irradiation schedule information for each time in each resin area. Then, as described with reference to FIGS. 4A to 4D and 5A to 5D in the first embodiment, the data conversion ratio is set in accordance with the predicted temperature distribution and temperature change.

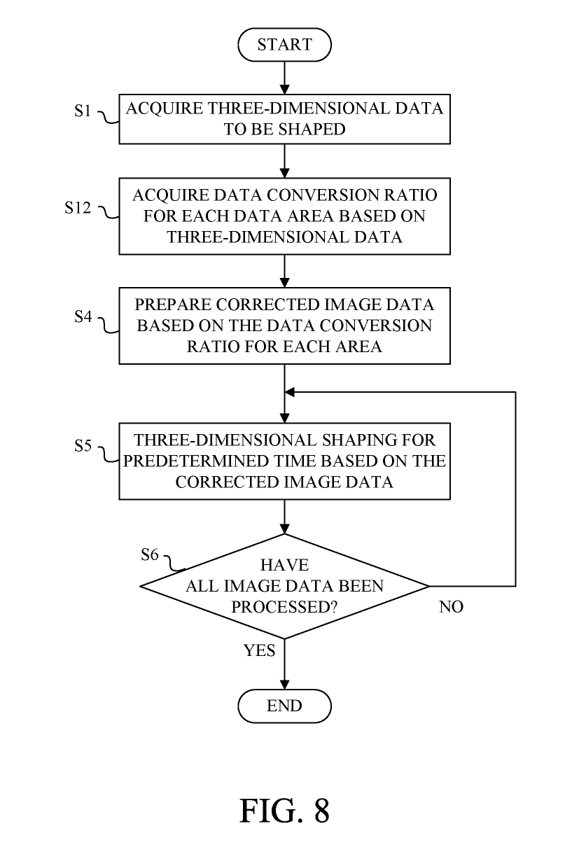

A flowchart in FIG. 8 illustrates a flow of a three-dimensional shaping process executed by the CPU 301 in accordance with a three-dimensional shaping program of this embodiment. The step S1 and steps S4 to S6 in the flowchart of FIG. 8 are the same as those in the flowchart illustrated in FIG. 3 according to the first embodiment.

In the step S12 in FIG. 8, the CPU 301 analyzes the three-dimensional data (a plurality of original image data) acquired in the step S1 and obtains the irradiation schedule information for each resin area in the UV curable resin RA during shaping as described above. Then, the data conversion ratio is acquired (set) for each data area in the three-dimensional data based on the temperature distribution and the temperature change in the UV curable resin RA during shaping predicted from the irradiation schedule information. Thereafter, the flow proceeds to the step S4.

This embodiment sets, without actually detecting the temperature, the data conversion ratio by predicting the temperature distribution and temperature change during shaping from the irradiation schedule information obtained by analyzing the three-dimensional data. Instead, another method of setting the data conversion ratio may be used which does not actually detect the temperature. For example, three-dimensional shape data for distortion calibrations may be prepared which is different from three-dimensional shape data for the shaped object WB, the shaped object for calibrations may be shaped, and the data conversion ratio may be set based on the measurement result of the shape of the shaped object for calibrations and stored in the storage unit 305.

The configuration described in this embodiment and the configurations described in the first and second embodiments may be combined with each other. For example, the data conversion ratio set based on the temperature distribution and the temperature change predicted by the configuration according to this embodiment may be corrected based on the temperature distribution and the temperature change actually detected during shaping in the configuration according to the first or second embodiment. This configuration can suppress the shaping distortion while the influence of the environmental temperature change during actual shaping different from that when the temperature distribution and the like are predicted.

Each of the above embodiments uses the data conversion ratio as the conversion information used to convert the three-dimensional shape data into the corrected image data (modulation control data). However, the conversion information does not necessarily have to be the exact data conversion ratio, but may be information on the data conversion ratio, such as a value obtained by converting the data conversion ratio into a coefficient.

### Fourth Embodiment

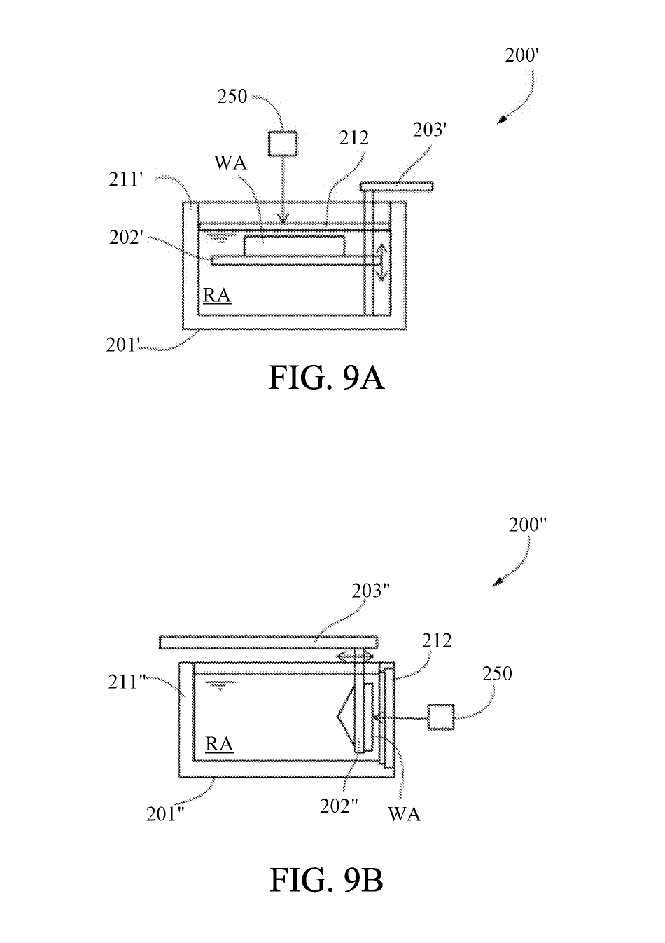

The first to third embodiments describe the image light irradiated onto the UV curable resin RA in the container 201 through the light transmitting plate 212 provided at the bottom of the container 201 in the shaping unit 200. However, as in the shaping unit 200′ according to a third embodiment of the present invention illustrated in FIG. 9A, the image light from the projection unit 250 may be irradiated onto the UV curable resin RA through the light transmitting plate 212 provided to a ceiling portion of the container 201′. In this case, the shaped layer WA may be sequentially formed by moving the holding plate 202′ downwardly by the moving mechanism 203′.

Further, as in the shaping unit 200″ illustrated in FIG. 9B, the image light from the projection unit 250 may be irradiated onto the UV curable resin RA through the light transmitting plate 212 provided on a side surface portion of the container 201″. In this case, the shaped layer WA may be sequentially formed while the moving mechanism 203″ moves the holding plate 202″ in the horizontal direction separating from the light transmitting plate 212.

Even in the configurations illustrated in FIGS. 9A and 9B, the temperature distributes and changes in the photocurable resin due to the heat generated by the environmental temperature fluctuations and photocuring of the photocurable resin. Thus, executing the three-dimensional shaping process described in the first to third embodiments can suppress the shaping distortion.

Each of the above embodiments has described a dead zone formed by oxygen that has permeates through the light transmitting plate 212. However, a releasing agent (releasing layer) different from the UV curable resin RA may be provided between the UV curable resin RA and the light transmitting plate 212, or the container 201 (201′, 201″) may be micro vibrated so as to prevent the shaped layer from adhering to the light transmitting plate 212.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The present invention can provide the good shaping accuracy even when a curing shrinkage factor distributes and changes in a photocurable resin during shaping, because the present invention sets conversion information for each data area accordingly.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An optical shaping apparatus comprising:
a container having a light-transmissive portion and configured to store a liquid photocurable resin;
a light modulation element having a plurality of pixels and configured to modulate light from a light source for each pixel;
an optical system configured to irradiate modulation light from the light modulation element onto the photocurable resin through the light-transmissive portion;
a convertor configured to convert three-dimensional data into a plurality of two-dimensional modulation control data using conversion information;
a controller configured to control the light modulation element based on each of the plurality of two-dimensional modulation control data; and
a moving member configured to move a cured portion cured by the modulation light among the photocurable resin in a direction separating from the light-transmissive portion,
wherein the convertor sets the conversion information for each data area corresponding to each of a plurality of resin areas in the three-dimensional shape data based on a distribution of a curing shrinkage factor in the plurality of resin areas that receive the modulation light in the photocurable resin.

2. The optical shaping apparatus according to claim 1, wherein the convertor sets the conversion information for each of the two-dimensional modulation control data.

3. The optical shaping apparatus according to claim 1, wherein the conversion information is information on a ratio between a unit area in the three-dimensional shape data and an irradiation area of the modulation light in the photocurable resin.

4. The optical shaping apparatus according to claim 3, wherein the convertor sets the ratio such that the higher the curing shrinkage factor is, the larger the irradiation area for the unit area is.

5. The optical shaping apparatus according to claim 1, wherein the conversion information is information on a ratio between a unit thickness in the three-dimensional shape data and an irradiation time of the modulation light onto the photocurable resin.

6. The optical shaping apparatus according to claim 5, wherein the convertor sets the ratio such that the higher the curing shrinkage ratio is, the longer the irradiation time onto the unit thickness becomes.

7. The optical shaping apparatus according to claim 1, wherein the convertor sets the conversion information in accordance with a temperature distribution or a temperature change in the photocurable resin.

8. The optical shaping apparatus according to claim 1, wherein the convertor sets the conversion information in accordance with the three-dimensional shape data.

9. The optical shaping apparatus according to claim 1, wherein the convertor sets the conversion information using irradiation schedule information of the modulation light onto the plurality of resin areas according to the three-dimensional shape data.

10. The optical shaping apparatus according to claim 1, wherein the convertor sets the conversion information according to information on a shape of the cured portion formed by controlling the light modulation element based on three-dimensional shape data for calibrations.

11. The optical shaping apparatus according to claim 1, wherein the convertor sets the conversion information using as an origin a center of a three-dimensional object expressed by the three-dimensional shape data or a center of a temperature distribution in the photocurable resin.

12. A manufacturing method configured to manufacture a three-dimensional object, the manufacturing method comprising the steps of:
storing a liquid photocurable resin in a container having a light-transmissive portion;
irradiating modulation light from a light modulation element through the light-transmissive portion onto the photocurable resin by controlling the light modulation element based on each of a plurality of two-dimensional modulation control data generated by converting three-dimensional shape data using conversion information, the light modulation element having a plurality of pixels and being configured to modulate light from a light source for each pixel;
moving a cured portion cured by the modulation light among the photocurable resin in a direction separating from the light-transmissive portion; and
setting the conversion information for each data area corresponding to each of a plurality of resin areas in the three-dimensional shape data based on a distribution of a curing shrinkage factor in the plurality of resin areas that receive the modulation light in the photocurable resin.

13. A non-transitory computer-readable storage medium storing an optically shaping program that enables a computer in an optical shaping apparatus to execute an optically shaping process, the optical shaping apparatus including a container having a light-transmissive portion and configured to store a liquid photocurable resin, a light modulation element having a plurality of pixels and configured to modulate light from a light source for each pixel, and an optical system configured to irradiate modulation light from the light modulation element onto the photocurable resin through the light-transmissive portion, the optically shaping process comprising the steps of:
converting three-dimensional shape data into a plurality of two-dimensional modulation control data using conversion information;
controlling the light modulation element based on each of the plurality of two-dimensional modulation control data;
moving a cured portion cured by the modulation light among the photocurable resin in a direction separating from the light-transmissive portion; and
setting the conversion information for each data area corresponding to each of a plurality of resin areas in the three-dimensional shape data based on a distribution of a curing shrinkage factor in the plurality of resin areas that receive the modulation light in the photocurable resin.
